(19) United States
(12) Patent Application Publication
(10) Pub. No.: US 2009/0015021 A1
(43) Pub. Date: Jan. 15, 2009

(54) SELF-SUPPORTING POWER GENERATION SYSTEM

(76) Inventor: Timothy D. Towada, Elmhurst, IL (US)

Correspondence Address: NEAL, GERBER, & EISENBERG, SUITE 2200, 2 NORTH LASALLE STREET, CHICAGO, IL, 60602, US

(21) Appl. No.: 11/854,969

(22) Filed: Sep. 13, 2007

Related U.S. Application Data
(63) Continuation of application No. 11/290,133, filed on Nov. 30, 2005, now abandoned.
(60) Provisional application No. 60/631,838, filed on Nov. 30, 2004.

(51) Int. Cl. H02K 7/18

(52) U.S. Cl. 290/1 A

(57) ABSTRACT

A scalable micro-grid for providing power to areas remote from the existing power grid. At least two power pods linked in parallel. Each power pod has at least one, micro-turbine fueled by methane gas. As power needs increase, additional power pods are added to the system to meet the additional power needs. The power pods have redundancy such as a diesel genset to ensure continuous power. Power pods are more environmentally friendly than diesel generators and independent of existing power grid. Installation of a power pods requires a short lead-time and thus can be put into operation as soon as the need for more power arises. The power generation source is close to the power consumption point. Removal cost is minimal and the equipment can be reused in another remote power generation locale.

### CROSS-REFERENCE

This application is a continuation application of U.S. patent application Ser. No. 11/854,969, filed on Sep. 13, 2007, which claimed the benefit of US Provisional Application No. 60/631,838, Filed Nov. 30, 2004, both of which are incorporated herein in their entireties by reference.

### BACKGROUND OF THE INVENTION

This invention relates generally to a scalable self-supporting power generation station utilizing divergent, but complimentary technologies for use in locations remote from an existing power grid.

It is, in some instances, necessary to have a power supply in a location remote from an existing electric power grid. For example, mining or drilling operations often occur in locations remote from an existing power grid. However, these activities still require a reliable, continuous source of power. There is need for a dependable, continuous power source to maintain operations in remote locations. The proper allocation of the respective power generation technologies is determined by the Supervisory Control and Data Acquisition (SCADA) tracking the dynamic loads.

For example, there are methane gas reserves in the western United States. The depth of the gas varies throughout the reserve. Where the gas is located closer to the surface, such as within 200 feet of the surface, small, 5 to 10 horsepower motors are sufficient to run the pumps. In other areas, the gas is located deeper in the earth—in some cases, over 1,500 feet below the surface. In such instances, pumps with 10 to 50 horsepower motors are needed to pump the gas in these areas. The wells are often located in areas remote from an existing power grid. Thus, there is a need for a method to provide reliable, continuous power to the wells in a cost effective manner. Further, there is a need for a power supply that is readily expandable to allow for expansion of the number of wells.

For example, the largest US gas exploration and production is located in remote northeast Wyoming and southeast Montana. There is expected to be 43,000 new wells over the next 13 years. Gas companies have traditionally utilized a central coal power generation plant with an electric grid eventually built out to the remote well sites. The electricity is required to power pumps that remove water from the wells and to compress the gas. Some gas companies also use portable diesel engine-generators as a means of power until the electric grid reaches the new well.

In the past, power was supplied to the wells, either by expanding the existing power grid, or by using diesel generators. Expanding the existing grid involves running high voltage lines to the well field. This solution is very costly to the gas company, as the power company requires the user to pay for the installation/expansion of the grid and for its removal at the end of the project, in addition to paying for the electricity, transmission charges and other fees. There is a need for a system that is economical and independent of the existing power grid.

A significant problem with expanding the existing power grid is the long lead-time needed for expansion. There is a need for a scalable solution where the expansion can occur in a time efficient manner so that companies can produce gas faster. There is a need for a system that allows for expansion in a relatively short time frame such as a similar time frame as is required to develop a new well.

The overhead towers and high voltage wires are obtrusive, unsightly and not environmentally friendly. The impact of overhead towers and high voltage wires is not insignificant. Gas companies have been stalled by lawsuits arising out of landowner complaints about the power lines and towers. Thus, there is a need for unobtrusive power generation that minimizes any negative effect on the environment. There is a need for a system that is better for the environment than expanding an existing power grid. A second prior art solution is to use diesel generators. However, there are environmental impact issues that arise when using diesel generators. There is a need for a system with minimal environmental impact. Further, using diesel generators is prohibitively expensive.

### SUMMARY OF THE INVENTION

A scalable, self-supporting power generation station is described herein. The station utilizes divergent, but complimentary technologies, such as reciprocating engine-generators with bi-fumigation and micro-turbines 30, for use in locations remote from an existing power grid.

The present invention comprises a scalable micro-grid for providing power to areas remote from an existing power-grid. The power system was developed to power a gas pumping operation. However, due to its scalability, the inventive system is not limited to pumping operations and can be used to power any remote system, such as drilling and mining.

The system comprises at least two power pods 10 linked in parallel. Each power pod 10 comprises at least one micro-turbine 30, fueled by methane gas. As the power needs increase, additional power pods 10 can be added to the system to meet the additional needs. The power pods 10 preferably have redundancy such as a diesel genset to ensure continuous power. A genset is a combustion engine driving an electrical generator. Not only are the power pods 10 more environmentally friendly than diesel generators, the power pods 10 are completely independent of existing power grids. The inventive system is better for the environment. It is clean burning and there are no overhead towers or high-voltage wires.

The power pods 10 have a short lead-time and thus can be put into operation as soon as the need for more power arises. The power generation source is close to the power consumption point. Any removal cost is minimal and the equipment can be reused in another remote power generation locale.

A better understanding of the objects, advantages, features, properties and relationships of the invention will be obtained from the following detailed description and accompanying drawings which set forth an illustrative embodiment and which are indicative of the various ways in which the principles of the invention may be employed.

### BRIEF DESCRIPTION OF DRAWINGS

For a better understanding of the invention, reference may be had to the following Figures, which further describe an embodiment of the present invention and which include drawings and exemplary screen shots therefor:

FIG. 1 is a flow chart depicting a first embodiment of a power pod as described in detail below.

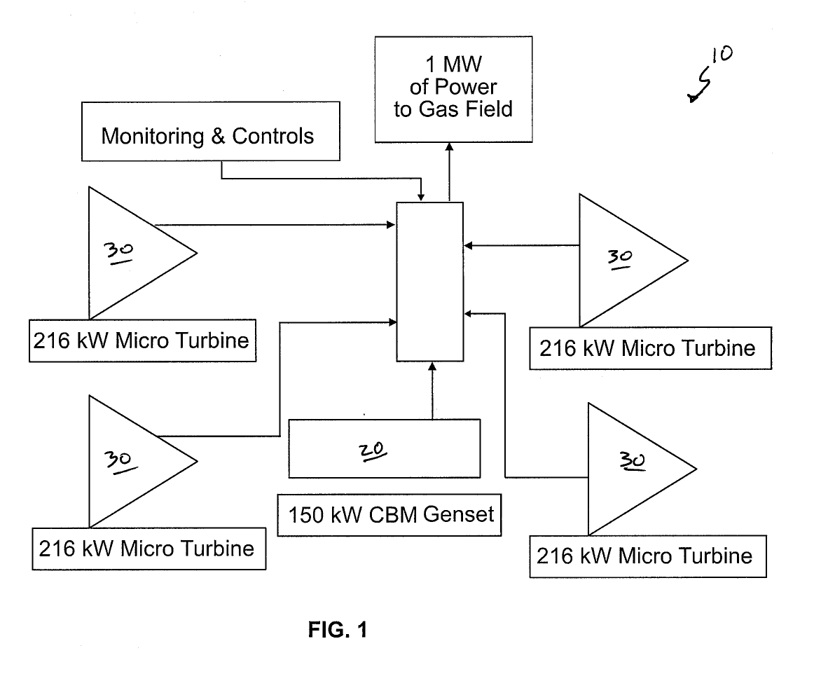

FIG. 2 is a schematic diagram of a first embodiment of a power pod as described in detail below

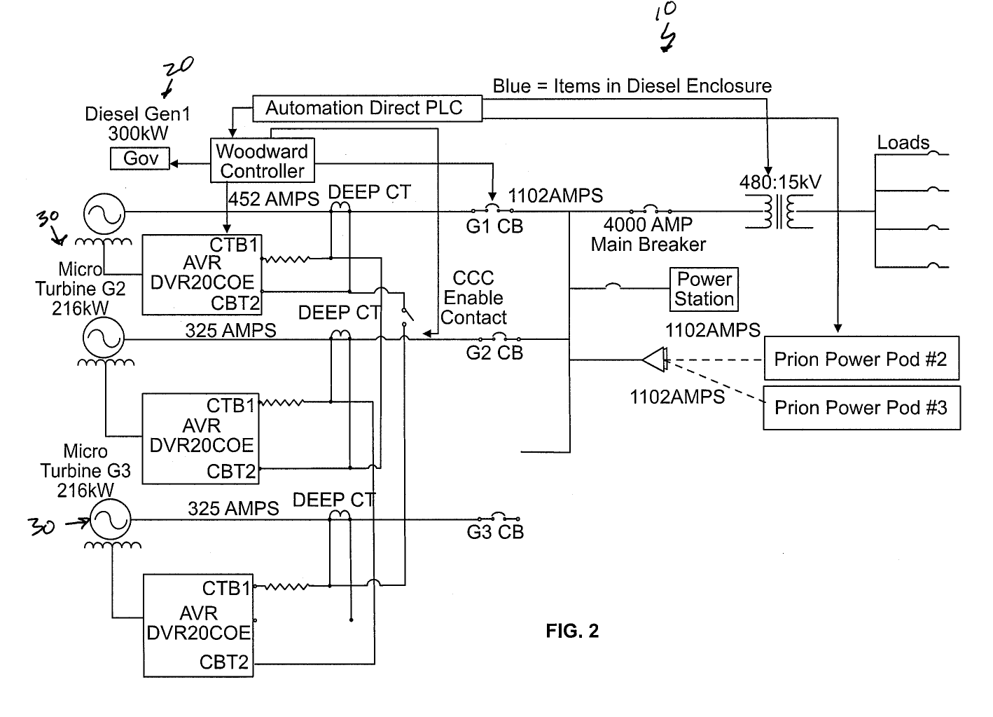

FIG. 3 is an isometric view of a first embodiment of the present invention.

### DETAILED DESCRIPTION

Turning now to the Figures, wherein like reference numerals refer to like elements, there is illustrated a self-supporting power generation station.

There are methane gas reserves in the western United States. The depth of the gas varies throughout the reserve. Where the gas is located closer to the surface, such as within 200 feet of the surface, small, 5 to 10 horsepower motors are sufficient to run the pumps. In other areas, the gas is located deeper in the earth—in some cases over 1,500 feet below the surface. Pumps with 10 to 50 horsepower motors may be needed to pump the gas in these areas. The deep wells are usually located in an area remote from any existing power grid. The present invention supplies reliable, continuous power to wells in a cost effective manner. Further, the power supply is readily expandable to allow for expansion of the number of wells.

The largest US gas exploration and production is located in remote northwest Wyoming and southeast Montana. 43,000 new wells are expected in the next 13 years. The present invention comprises a system to supply power to these remote wells in a scalable, cost effective, prompt and environmentally-friendly manner.

Methane gas wells typically run 24 hours a day, every day of the year. Therefore, it is important that the power source have at least one built-in redundancy. In addition, it is preferable that gross power generated exceeds the peak demand. By way of example, and in no way limiting, a well field having 32 wells, where on average each well has a 10-horsepower motor, two power pods 10 may be used, connected in series. In this scenario, each power pod 10 services 16 wells. Preferably, the power pods 10 are located in a central location.

As seen in the figures, each power pod 10 may comprise reciprocating engine-generator 20, which may be fueled by a combination of coal bed methane (CBM) gas and diesel fuel and at least one micro-turbine 30. Reciprocating engine generator 20 supports dynamic loading and redundancy. Depending on load dynamics (as monitored by SCADA), reciprocating engine generator 20 may be in one of three states: (i) not running or steady state load; (ii) running in parallel with micro-turbine 30 at a ratio determined by the load or SCADA; or (iii) supporting the entire dynamic load such as when micro-turbines 30 are not running.

Power pod 10 preferably comprises two or four micro-turbines 30 fueled by CBM. Micro-turbines 30 are preferably connected in parallel, and support base-loading steady state load conditions. Depending on load dynamics (as monitored by SCADA), micro-turbines 30 may be in one of three states: (i) not running or dynamic load; (ii) running in parallel with reciprocating engine generator 20 at a ratio determined by the load or SCADA; or (iii) supporting the entire load in a steady state base load when reciprocating engine generator 20 is not running.

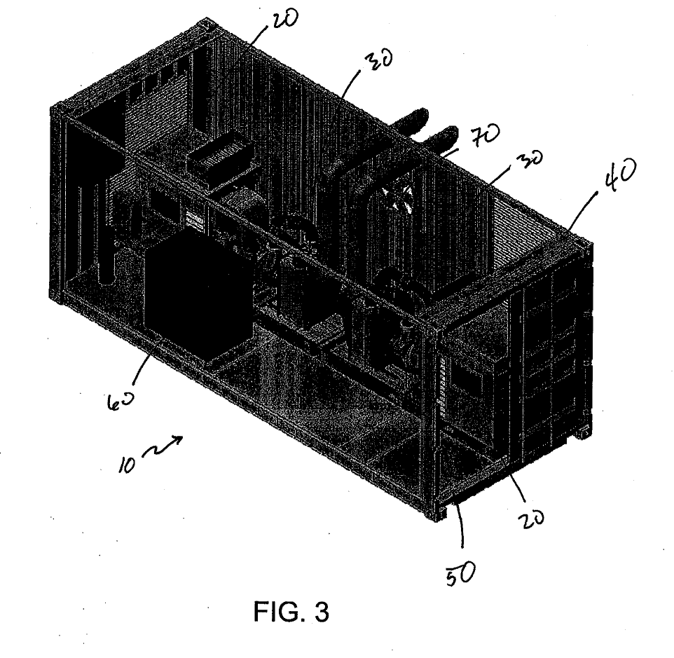

As seen, for example, in FIG. 3, power pod 10 comprises at least one enclosure 40. Enclosure 40 is preferably an all weather enclosure. Preferably, there are two enclosures 40. First enclosure 40 may house controls 60 and distribution equipment (not shown), while second enclosure 40 may house generators 20 and micro-turbines 30. Alternatively, bi-fuel reciprocating genset (not shown) can be used in addition to micro-turbines 30. Enclosure 40 may be transportable. In the embodiment depicted in FIG. 3, enclosure 40 measures 8 feet wide, 8.5 feet high and 20 feet long. Preferably, enclosure 40 comprises access door 50. Enclosure 40 may operate alone or in combination with a second enclosure 40 with controls 60. Preferably, power pod 10 comprises two enclosures 40. Preferably, enclosure 40 is an 8-foot by 20-foot Iso Containers to house micro-turbines 30.

Power pod 10 may be pre-assembled to allow for rapid transportation to a desired location for set-up. A pre-assembled power pod 10 may comprise an enclosure 40 with two micro-turbines 30, a control system 60, power electronics (not shown), lubricating oil systems (not shown), an engine alternator assembly (not shown), a recuperator (not shown), a gas boost compressor (not shown), ventilation 70, and a power panel (not shown). A distribution panel can be added to provide power distribution feed.

As stated above, each enclosure 40 preferably houses two micro-turbines 30. Preferably, the micro-turbines 30 are rated 80 kW each with a gas compressor. Each power pod 10 preferably also comprises a 300 kW reciprocating generator with weather proof enclosure mounted on skid with SCADA equipment (such as Virtual Power Plant™ by Encorp) with weather proof enclosure mounted on the same skid as reciprocating generator 20. Generator 20 preferably comprises a bi-fumigation system.

Power pod 10 preferably also includes hardware and software (not shown) to access each power pod 10 via telephone or computer network for remote control, such as start-up, stop, configuration management and troubleshooting.

Preferably, generators 20 are fueled by unprocessed methane gas. Alternative fuel sources could be used. However, unprocessed coal bed methane gas is accessible at the generation site. The methane gas should be supplied at sufficient pressure to facilitate generators 20. Generators 20 preferably generate power at 480 V. It is preferable that the gross power generated by power pods 10 exceeds peak demand. For example, if a power pod 10 services 16 wells with an average 10 hp motor, the gross power generated exceeds the peak demand by 73%. It is also preferable that there is redundancy in the system since the pumps run continuously. In one embodiment (not shown), diesel generators or preferably bi-fuel reciprocating generators are used as back up. In an alternative embodiment, if one power pod 10 fails, excess gross power of one or more operating power pods 10 is used to supply pumps. In yet another embodiment, redundancies in the system include both at least one diesel generator or one bi-fuel reciprocating genset and the ability to use the excess power generated.

A typical well production area can be serviced by a power pod 10 having four micro-turbines 30, each producing 320 kW of continuous power to service approximately 20 wells. There is approximately one “drop” supporting every 3-4 wells or approximately 6-7 drops from each power pod 10 to the wells.

Optionally, the power pods 10 can include virtual control devices to increase the control and efficiency of the pumps. It is preferable that the harmonics are kept within IEEE 519 limits by use of harmonic transformers. One virtual control that would be suitable for this application is Virtual Power Plant™, which monitors the load dynamics so the proper ratio of power generation resources (reciprocating generators 20 to micro-turbines 30) is utilized. Virtual controls also provide for paralleling of power generation resources, diagnostics, monitoring, service alarm cell out and future import/export of power to accommodate micro grids.

Linked power pods 10 act as a micro-grid for servicing the well field. The micro-grid can be expanded by linking additional power pods 10 to the system. Preferably, additional power pods 10 are added by connecting adjoining cites via radial drops. Power pod 10 is preferably monitored via satellite. This is useful since the power pod 10 is used in relatively remote locations. Micro-turbines 30, generators 20, fuel level, paralleling gear, SCADA and MCC are all monitored. Preferably, the controls include internal diagnostics and allow a user to make some repairs and run diagnostic testing via satellite or other communication network.

During the initial set up of a power pod 10 for a methane gas well field, bi-fuel genset of power pod 10 runs on diesel fuel. As the pumps begin to supply unprocessed methane gas, micro-turbines 30 are energized. Initially, the well field's power requirements may be more dynamic than the micro-turbines 30 can tolerate. In that case, micro-turbines 30 will supply the baseline power, while generator 20 will provide additional power to power the motor at peak load times. After a time, micro-turbines 30 are able to supply in excess of the well fields power needs. At that point, generators 20 will be used as a back-up power supply only. Additional back-up power can be provided to other power pods 10 on the micro grid.

Power pods 10 are environmentally friendly. Micro-turbines 30 may run on methane gas, while generators 10 may run on 20% diesel and 80% natural gas and thus burn cleaner than a traditional diesel genset.

Two power pods 10 can be connected in series to form a micro-grid. Additional power pods 10 can be added to the micro-grid via radial drops. Thus, the system is scalable.

Power pods 10 use natural gas and thus are environmentally friendly. Furthermore, they can be moved to another location and used again.

Power pods 10 can be started using the bi-fuel genset running on diesel fuel only, thus a power pod 10 is completely independent of existing power grids.

Because enclosure 40 may be fully assembled, power pod 10 can be operational with a very short lead time. The transportable enclosure 40 can be moved to a location, installed and be up and running with a very short lead-time. It can be linked to other power pods 10 to form a micro-grid. When the power needs change, additional power pods 10 can be added or removed. The transportable power pod 10 could be moved to another location. Power pod 10 is a more economical, cost effective and timely solution than the prior art remote power generation. It is also a more environmentally friendly solution than the prior art solutions.

While specific embodiments of the present invention have been described in detail, it will be appreciated by those skilled in the art that various modifications and alternatives to those details could be developed in light of the overall teachings of the disclosure. In addition, it is to be understood that all patents discussed in this document are to be incorporated herein by reference in their entirety. Accordingly, the particular arrangement disclosed is meant to be illustrative only and not limiting as to the scope of the invention which is to be given the full breadth of the appended claims and any equivalents thereof.

1. A power pod comprising
at least one reciprocating engine generator and
at least one micro turbine fueled,
wherein the engine-generator is in a not running state, a steady state load, running in parallel with the micro turbine, or supporting the entire load dynamic load.

2. The power pod of claim 1 wherein the engine generator is fueled by a combination of coal bed methane (CBM) gas and diesel fuel and the micro turbine is fueled by CBM.

3. The power pod of claim 1 further comprising at least two micro turbines connected.

4. The power pod of claim 2 further comprising at least two micro turbines connected in parallel.

5. The power pod of claim 4 wherein the micro turbines are in a not running state, a steady state load, running in parallel with the engine generator, or supporting the entire load dynamic load.

6. The power pod of claim 2 further comprising at least one enclosure.

7. The power pod of claim 6 wherein the enclosure is an all weather enclosure.

8. The power pod of claim 4 further comprising:
A control system,
power ditricution equipment
a first and a second enclosure
wherein the first enclosure houses controls and distribution equipment and the second enclosure houses the engine generator and the micro-turbines.

9. The power pod of claim 8 wherein each housing is transportable.

10. The power pod of claim 7 further comprising a bi-fuel reciprocating genset

11. The power pod of claim 7 further comprising:
power electronics,
a lubricating oil system,
an engine alternator assembly,
a recuperator, and
a gas boost compressor.

12. The power pod of claim 7 further comprising hardware and software to a\for remote access to each power pod via telephone or computer network for remote control, start, stop, configuration management, and troubleshooting.

13. The power pod of claim 3 further comprising a diesel generators or a bi-fuel reciprocating gensets.

14. The power pod of claim 3 wherein the power pod if connected to at least one additional power pod to form a microgrid.

15. The power pod of claim 3 wherein the power pod data is monitored via satellite, power pod data compromises one or more of micro-turbines status, diesel bi-fuel reciprocating gen-set status, fuel level, paralleling gear status, SCADA and MCC.
